(19) United States
(12) Patent Application Publication
(10) Pub. No.: US 2015/0093923 A1
(43) Pub. Date: Apr. 2, 2015

(54) TERMINAL

(71) Applicant: LOTES CO., LTD, Keelung (TW)

(72) Inventor: Ted Ju, Keelung (TW)

(73) Assignee: LOTES CO., LTD, Keelung (TW)

(21) Appl. No.: 14/091,099

(22) Filed: Nov. 26, 2013

(30) Foreign Application Priority Data
Sep. 27, 2013 (CN) 201320600466.6

(51) Int. Cl. H01R 13/02

(52) U.S. Cl. CPC H01R 13/02
USPC 439/83

(57) ABSTRACT

A terminal includes a contact portion and a soldering portion for being soldered to a circuit board. A metal coating is plated on the contact portion and is made of a chromium-carbon material, so that the contact portion has desirable electric conductivity and strong hardness, and has desirable corrosion resistance. Hence, a manufacturing process of the terminal uses a common chromium-carbon material to form the metal coating to replace a gold conductive layer, thereby reducing the manufacturing cost of the terminal. Further, it is unnecessary to use toxic substances during plating, which greatly reduces environmental pollution, and effectively protects the environment.

### CROSS-REFERENCE TO RELATED APPLICATION

This non-provisional application claims priority under 35 U.S.C. §119(a) on Patent Application No. 201320600466.6 filed in P.R. China on Sep. 27, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a terminal, and more particularly to a terminal having a metal coating.

### BACKGROUND OF THE INVENTION

The existing terminal, in order to make the terminal have stable electric conductivity and desirable corrosion resistance, generally may be plated with a gold conductive layer having a thickness of 20 μ″m (1 μ″m=0.025 μm) at the contact portion of the terminal during manufacturing. As the gold material is very rare and its cost is very high, plating of the gold conductive layer on the terminal increases the manufacturing cost of the terminal, and makes the manufacturing cost of the terminal expensive. During gold plating, in order to obtain the gold conductive layer, potassium auric cyanide must be used. Potassium auric cyanide is a reagent for gold plating, mainly used in acidic-range gold plating and plating of gold alloy. It is necessary to use a large quantity of potassium auric cyanide in the process of plating the gold conductive layer so as to obtain the required gold conductive layer. However, potassium auric cyanide is a highly toxic substance and seriously pollutes the environment, and use of potassium auric cyanide seriously undermines the environment for human survival.

Therefore, a heretofore unaddressed need exists in the art to address the aforementioned deficiencies and inadequacies.

### SUMMARY OF THE INVENTION

In one aspect, the present invention is directed to a terminal having stable electric conductivity and a low manufacturing cost.

In one embodiment, a terminal includes a contact portion and a soldering portion. The soldering portion is used for being soldered to a circuit board. A metal coating is plated on the contact portion. The metal coating is made of a chromium-carbon material.

In one embodiment, the soldering portion is plated with a tin layer.

In one embodiment, the metal coating extends to an end of the soldering portion, to block climb tin at the end of the soldering portion.

In one embodiment, the metal coating has a thickness of 100 nm to 1500 nm.

In one embodiment, a weight percentage of carbon in the metal coating is 1%-30%.

In one embodiment, a particle size of the metal coating is less than 1000 nm.

In one embodiment, the terminal has a substrate. The substrate is provided with the contact portion and the soldering portion, and a nickel coating is plated between the soldering portion and the tin layer.

Further, the nickel coating extends along the substrate to be located between the contact portion and the metal coating.

In one embodiment, the terminal has a substrate. A multi-layer coating is plated on a surface of the substrate. The multi-layer coating is made of a nickel alloy material. The multi-layer coating has at least two coatings. At least one of the coatings in the multi-layer coating is a coating having fine tissue particles, at least one of the coatings is a coating having coarse tissue particles and located at an outermost side of the multi-layer coating. The metal coating is located on the outermost coating having coarse tissue particles.

In one embodiment, the multi-layer coating includes a first coating, a second coating, and a third coating. The third coating is located at an outermost side of the multi-layer coating. At least one of the first coating and the second coating is a coating having fine tissue particles. The third coating is a coating having coarse tissue particles. The metal coating is located on the third coating.

In one embodiment, the first coating and the second coating are alternately laminated.

In one embodiment, the second coating is located on the first coating. The first coating is a coating having coarse tissue particles, and the second coating is a coating having fine tissue particles.

In one embodiment, the second coating is of a nano-crystalline structure.

In one embodiment, the second coating has a thickness of 100 nm to 300 nm, and thicknesses of the first coating and the third coating are 1-3 times the thickness of the second coating.

In one embodiment, a gold coating is further plated on the metal coating.

Compared with the related art, the present invention has the following beneficial advantages. The terminal has the contact portion, the metal coating is plated on the contact portion, the metal coating is made of a chromium-carbon material, so that the contact portion has stable electric conductivity and strong hardness, as well as desirable corrosion resistance; hence. A manufacturing process of the terminal can use a chromium-carbon material to replace gold materials, to avoid using the gold materials. Using a common chromium-carbon material to form the metal coating to replace the gold conductive layer reduced the manufacturing cost of the terminal. Further, it is unnecessary to use toxic substances during plating, which greatly reduces environmental pollution, and effectively protects the environment.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a side view of a terminal according to one embodiment of the present invention.

FIG. 2 is a partially enlarged view of FIG. 1.

FIG. 3 is a partially enlarged view of FIG. 2.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

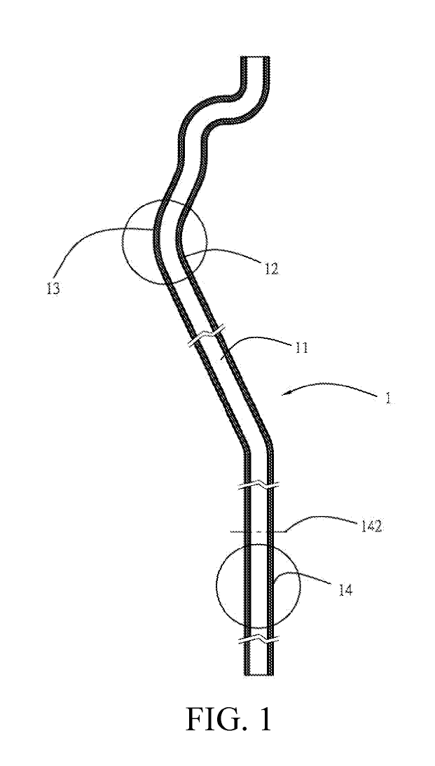

As shown in FIGS. 1-3, a terminal 1 according to one embodiment of the present invention has a substrate 11. The terminal 1 includes a contact portion 13 and a soldering portion 14. The contact portion 13 is used for contacting a connecting terminal (not shown). The soldering portion 14 is used for being soldered to a circuit board (not shown). A metal coating 131 is plated on the contact portion 13. The metal coating 131 is made of a chromium-carbon material. A tin layer 141 is plated on the soldering portion 14.

As shown in FIGS. 1-3, the substrate 11 includes the contact portion 13 and the soldering portion 14. In this embodiment, a multi-layer coating 12 is plated on the substrate 11, i.e., the multi-layer coating 12 is plated on both the contact portion 13 and the soldering portion 14. The multi-layer coating 12 has at least two coatings, the metal coating 131 is located on the multi-layer coating 12, and the tin layer 141 is also located on the multi-layer coating 12. In another embodiment, the multi-layer coating 12 is not plated on the substrate 11. A nickel coating is plated between the soldering portion 14 and the tin layer 141 (not shown), i.e., the nickel coating is only plated on the soldering portion 14. The nickel coating is not plated on the contact portion 13, and only the metal coating 131 is plated on the contact portion 13. In other embodiments, the nickel coating extends along the substrate 11 to be located between the contact portion 13 and the metal coating 131 (not shown), i.e., one layer of the nickel coating is plated on both the contact portion 13 and the soldering portion 14, the tin layer 141 is located on the nickel coating, and the metal coating 131 is located on the nickel coating.

As shown in FIGS. 1-3, the multi-layer coating 12 is plated on the substrate 11. The multi-layer coating 12 is made of a nickel alloy material. The multi-layer coating 12 includes nickel-tungsten alloy. The multi-layer coating 12 has at least two coatings. In this embodiment, the multi-layer coating 12 includes three layers of coating. In other embodiments, the number of the coatings of the multi-layer coating 12 may be any number greater than two. At least one of the coatings in the multi-layer coating 12 is a coating having fine tissue particles for preventing corrosion factors from entering the substrate 11, avoiding that the substrate 11 is oxidized and corroded, so that the antioxidation capability of the terminal 1 is enhanced and the service life is long. At least one of the coatings has coarse tissue particles and is located at an outermost side of the multi-layer coating 12. The tin layer 141 is plated on the soldering portion 14. The tin layer 141 is used for being soldered to the circuit board (not shown). The tin layer 141 is located on the multi-layer coating 12. The tin layer 141 is plated on the coating having coarse tissue particles and located at an outermost side of the multi-layer coating 12. The coating, having coarse tissue particles and being located at an outermost side of the multi-layer coating 12, has great hydrophilicity. Coarse tissue particles in the coating have gaps therebetween. The tin layer 141 is not only in contact with a surface of the coating having coarse tissue particles but also extends into the gaps between the coarse tissue particles and contacts them, so that the effective contact area of the tin layer 141 is increased, which easily makes the tin layer 141 attached to the coating having coarse tissue particles, and makes soldering of the terminal 1 convenient and firm.

As shown in FIGS. 1-3, the multi-layer coating 12 includes a first coating 121, a second coating 122, and a third coating 123. The third coating 123 is located at an outermost side of the multi-layer coating 12. At least one of the first coating 121 and the second coating 122 is a coating having fine tissue particles. The third coating 123 is a coating having coarse tissue particles. The first coating 121 and the second coating 122 are alternately laminated. The tin layer 141 is located on the third coating 123, and the metal coating 131 is located on the third coating 123. The metal coating 131 extends to an end 142 of the soldering portion 14. The end 142 of the soldering portion 14 is a boundary of the terminal 1 where soldering is required and soldering is not required, and the metal coating 131 is not overlapped with the tin layer 141.

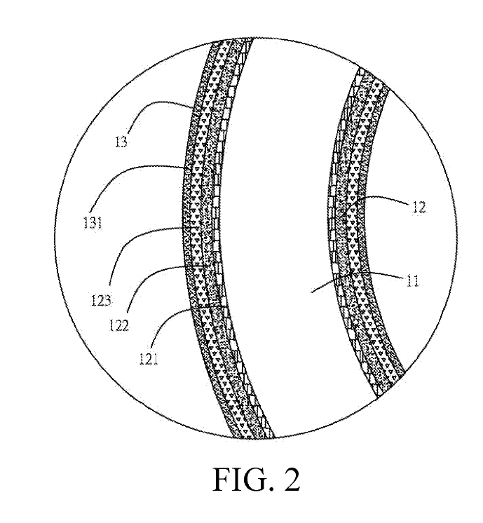

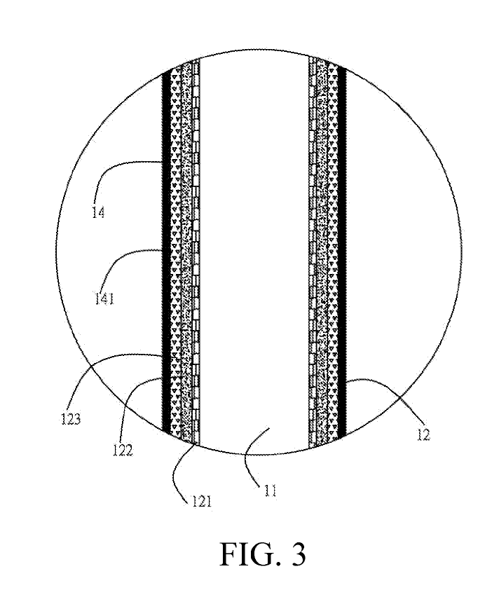

As shown in FIG. 2 and FIG. 3, in this embodiment, the multi-layer coating 12 only has three layers, which are sequentially the first coating 121, the second coating 122, and the third coating 123. The second coating 122 is a coating having fine tissue particles, and the second coating 122 is located between the first coating 121 and the third coating 123. That is, the first coating 121 is located on a surface of the substrate 11, the second coating 122 is located on the first coating 121, the third coating 123 is located on the second coating 122, and the first coating 121 and the third coating 123 are coatings having coarse tissue particle. The second coating 122 includes nickel and tungsten, and a weight percentage of tungsten in the second coating 122 is 10%-20%. The second coating 122 includes nickel and tungsten, the second coating 122 is made of a nickel-tungsten alloy material. Nickel-tungsten alloy has strong corrosion resistance. Thus, the terminal 1 is easily exposed to a corrosive liquid (e.g., salt fog, an acetic acid solution or a solution containing an alkaline content), or corrosive environments as steam or humid environments in use. The terminal 1 is plated with the multi-layer coating 12 and could provide multiple protection over the substrate 11, and the second coating 122 is made of a nickel-tungsten alloy material. Thus, the second coating 122 has strong corrosion resistance, and could block corrosive factors from entering the substrate 11, to avoid that the terminal 1 is corroded, thereby increasing durability of the terminal 1. The particle size of the second coating 122 is less than 1000 nm, and the second coating 122 is of a nano-crystalline structure. The second coating 122 has a thickness of 100 nm to 300 nm, and thicknesses of the first coating 121 and the third coating 123 are 1-3 times the thickness of the second coating 122.

As shown in FIG. 2, in one embodiments, the first coating 121 is a coating having fine tissue particles and the first coating 121 is located on a surface of the substrate 11. The second coating 122 is located on the first coating 121. The second coating 122 may be a coating having fine tissue particles or a coating having coarse tissue particles. The third coating 123 is a coating having coarse tissue particles.

As shown in FIG. 1 and FIG. 2, the contact portion 13 is used for contacting the connecting terminal. The contact portion 13 has the metal coating 131. The metal coating 131 is located on the coating having coarse tissue particles and located at an outermost side of the multi-layer coating 12, i.e., the metal coating 131 is located on the third coating 123. The metal coating 131 is made of a chromium-carbon alloy material, a weight percentage of carbon in the metal coating 131 is 1%-30%, the particle size in the metal coating 131 is less than 1000 nm, and the particles in the metal coating 131 are at a nano level. As the metal coating 131 is made of chromium-carbon alloy, the contact portion 13 has stable electric conductivity and strong hardness, as well as desirable corrosion resistance. Hence, a manufacturing of the terminal 1 can use a chromium-carbon material to replace gold materials, to avoid using the gold materials. Using a common chromium-carbon material to form the metal coating 131 to replace the gold conductive layer, which not only makes the terminal have stable electric conductivity and desirable corrosion resistance, thereby reducing the manufacturing cost of the terminal, but also it is unnecessary to use toxic substances during plating, which greatly reduces environmental pollution, and effectively protects the environment.

As shown in FIG. 3, as the metal coating 131 is made of a chromium-carbon alloy material and the particles in the metal coating 131 are at a nano level, it is difficult to attach the tin layer 141 to the metal coating 131, that is to say, no tin climbs on the metal coating 131. The metal coating 131 extends to the end 142 of the soldering portion 14, to block climb tin at the end 142 of the soldering portion 14, thereby avoiding that the tin layer 141 extends upwards along the metal coating 131 to the contact portion 13 to affect the electric conductivity of the contact portion 13, which also stops that upward extension of the tin layer 141 results in reduction or even disappearance of the tin layer 141 and then affects soldering of the soldering portion 14. However, the metal coating 131 may not go beyond the end 142 of the soldering portion 14, which thus smoothly plates the tin layer 141 on the soldering portion 14, and ensures that the soldering portion 14 is firmly soldered to the circuit board.

As shown in FIG. 2, a gold coating (not shown) may further plated on the metal coating 131, used for reducing impedance of the terminal 1, and improving the electric conductivity of the terminal 1. As the metal coating 131 is plated on the contact portion 13, and the metal coating 131 is made of a chromium-carbon alloy material, it can be ensured that the terminal 1 and the connecting terminal are normally conducted. However, in order to make the terminal 1 have better electric conductivity, it is necessary to plate the gold coating on the metal coating 131, as one thicker metal coating 131 has been plated on the contact portion 13, it is only necessary to plate one thin layer of the gold coating, in which the thickness of the gold coating is only below 3 μ″m (1 μ″m=0.025 μm). It is only necessary to use fewer gold materials, which has a lower cost, uses fewer toxic substances during plating, and may not cause damage to the environment.

In summary, the terminal 1 according to certain embodiments of the present invention has the following beneficial advantages.

(1) The chromium-carbon alloy material has desirable electric conductivity and desirable corrosion resistance as well as high hardness, so that the contact portion 13 has stable electric conductivity and strong hardness, and has desirable corrosion resistance. Thus a manufacturing process of the terminal 1 can use a chromium-carbon material to replace the gold materials, to avoid using the gold materials. Using a common chromium-carbon material to form the metal coating 131 to replace the gold conductive layer not only makes the terminal have stable electric conductivity and desirable corrosion resistance, thereby reducing the manufacturing cost of the terminal 1, but also it is unnecessary to use toxic substances during plating, which greatly reduces environmental pollution, and effectively protects the environment.

(2) As the metal coating 131 is made of the chromium-carbon alloy material, it is difficult for the tin layer 141 to be attached to the metal coating 131. That is to say, no tin climbs on the metal coating 131. The metal coating 131 extends to the end 142 of the soldering portion 14, to block climb tin at the end 142 of the soldering portion 14, thereby avoiding that the tin layer 141 extends upwards along the metal coating 131 to the contact portion 13 to affect the electric conductivity of the contact portion 13, which stops that upward extension of the tin layer 141 results in reduction or even disappearance of the tin layer 141 and then affects soldering of the soldering portion 14, so that the tin layer 141 is smoothly plated on the soldering portion 14, ensuring that the soldering portion 14 is firmly soldered to the circuit board, and preventing occurrence of siphonage.

(3) The tin layer 141 is located on the multi-layer coating 12 and the tin layer 141 is plated on the third coating 123 located at the outermost side of the multi-layer coating 12. The third coating 123 has great hydrophilicity, and coarse tissue particles in the third coating 123 have gaps therebetween. Thus, the tin layer 141 is not only in contact with a surface of the third coating 123 but also extends into the gaps between the coarse tissue particles and contacts them, so that the effective contact area of the tin layer 141 is increased, which easily makes the tin layer 141 attached to the third coating 123, and makes the soldering portion 14 to firmly solder the terminal 1 on the circuit board by using the tine layer 141.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A terminal, comprising:
a contact portion; and
a soldering portion used for being soldered to a circuit board;
wherein a metal coating is plated on the contact portion; and
wherein the metal coating is made of a chromium-carbon material.

2. The terminal according to claim 1, wherein the soldering portion is plated with a tin layer.

3. The terminal according to claim 2, wherein the metal coating extends to an end of the soldering portion, to block climb tin at the end of the soldering portion.

4. The terminal according to claim 1, wherein the metal coating has a thickness of 100 nm to 1500 nm.

5. The terminal according to claim 1, wherein a weight percentage of carbon in the metal coating is 1%-30%.

6. The terminal according to claim 1, wherein a particle size of the metal coating is less than 1000 nm.

7. The terminal according to claim 2, wherein the terminal has a substrate, the substrate is provided with the contact portion and the soldering portion, and a nickel coating is plated between the soldering portion and the tin layer.

8. The terminal according to claim 7, wherein the nickel coating extends along the substrate to be located between the contact portion and the metal coating.

9. The terminal according to claim 2, wherein the terminal has a substrate, a multi-layer coating is plated on a surface of the substrate, the multi-layer coating is made of a nickel alloy material and has at least two coatings, at least one of the coatings in the multi-layer coating has fine tissue particles, at least one of the coatings has coarse tissue particles and located at an outermost side of the multi-layer coating, and the metal coating is located on the outermost coating having coarse tissue particles.

10. The terminal according to claim 9, wherein the multi-layer coating comprises a first coating, a second coating, and a third coating, the third coating is located at the outermost side of the multi-layer coating, at least one of the first coating and the second coating has fine tissue particles, the third coating has coarse tissue particles, and the metal coating is located on the third coating.

11. The terminal according to claim 10, wherein the first coating and the second coating are alternately laminated.

12. The terminal according to claim 10, wherein the second coating is located on the first coating, the first coating has coarse tissue particles, and the second coating has fine tissue particles.

13. The terminal according to claim 10, wherein the second coating is of a nano-crystalline structure.

14. The terminal according to claim 10, wherein the second coating has a thickness of 100 nm to 300 nm, and thicknesses of the first coating and the third coating are 1-3 times the thickness of the second coating.

15. The terminal according to claim 1, further comprising a gold coating plated on the metal coating.
